(19) United States
(12) Patent Application Publication
(10) Pub. No.: US 2011/0260870 A1
(43) Pub. Date: Oct. 27, 2011

(54) Method of preventing an inmate from committing suicide

(76) Inventor: Melanie Bailey, Firth, NE (US)

(21) Appl. No.: 12/799,243

(22) Filed: Apr. 21, 2010

(51) Int. Cl. G08B 23/00

(52) U.S. Cl. 340/573.1

(57) ABSTRACT

A method of preventing an inmate from committing suicide is disclosed wherein an oximeter having an RF transmitter associated therewith is mounted on a bracelet which is locked onto the inmate's wrist or ankle. The RF transmitter transmits data collected by the oximeter and furnishes the same to a control station monitor including an RF receiver. Should the oximeter sense that the oxygen saturation level of the inmate has dropped to a predetermined level, an alarm is automatically activated to enable personnel to rush to the inmate's cell or room. If the oximeter is a pulse oximeter, pulse rate data will also be transmitted to the central station so that the alarm will be activated should the pulse rate of the inmate drop to a predetermined level.

### BACKGROUND OF THE INVENTION

1. Field of the Invention

This invention relates to a method of preventing an inmate from committing suicide and more particularly to a method of preventing an inmate from committing suicide by placing a bracelet on the inmate's wrist or ankle with the bracelet including a pulse oximeter and an RF transmitter associated therewith which will transmit a signal containing the calculated oxygen saturation level of the inmate's blood to a central control station. Even more particularly, this invention relates to a method wherein the RF transmitter submits the data obtained by the oximeter to a radio receiver at the control station which will automatically activate an alarm should the oxygen saturation level or pulse rate of the inmate drop to a predetermined level.

2. Description of the Related Art

Incarcerated prisoners or inmates sometimes attempt suicide. The same is also true for patients in a psychiatric ward or hospital. Perhaps the most common method of suicide attempted by an inmate is strangulation by hanging. A second method frequently employed by inmates to commit suicide is to slash their wrists. Those inmates who are believed to be a threat to commit suicide are usually placed on a suicide watch which means that the inmate must be periodically checked and preferably continuously checked to prevent the inmate from committing suicide. The requirement that the inmate be continually observed results in a huge amount of manpower being expended. If the inmate is only checked or observed periodically, the inmate may commit suicide between the checks or observations.

When a person attempts suicide by hanging, the oxygen saturation level of the person's blood will drop dramatically. The same is also true with the person's pulse rate.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A method of preventing an inmate from committing suicide is disclosed which comprises the steps of:
(1) Providing an oximeter, and preferably a pulse oximeter, having an RF transmitter associated therewith which will transmit a signal which contains data relating to the calculated oxygen saturation level of the blood of the inmate and the pulse rate of the inmate;
(2) Locking the oximeter and an RF transmitter onto the ankle or wrist of the inmate so that the oximeter will sense and calculate the oxygen level of the inmate's blood;
(3) Providing a monitor including an RF receiver in a location remote from the inmate;
(4) Transmitting an RF signal containing the calculated oxygen saturation level of the inmate and/or the pulse rate of the inmate to the monitor so that the monitor will be alerted that the inmate is attempting suicide should the oxygen saturation level of the inmate's blood drop to a certain level or should the pulse rate of the inmate drop to a certain level; and
(5) Alerting a staff member through an audio and/or visual alarm that the inmate is possibly attempting to commit suicide.

It is therefore a principal object of the invention to provide a method of preventing an inmate from committing suicide.

A further object of the invention is to provide a method of preventing an inmate from committing suicide wherein a bracelet is locked onto either the wrist or ankle of the inmate with the bracelet including a pulse oximeter having an RF transmitter associated therewith that transmits a signal that contains the contains the calculated oxygen saturation level of the inmate's blood to an RF receiver in a location remote from the inmate with an alarm being sounded when indicated should the oxygen saturation level of the inmate drop to a predetermined level or should the pulse rate of the inmate drop to a predetermined level.

A further object of the invention is to provide a method of preventing an inmate from committing suicide which eliminates the need for continually or periodically observing the inmate.

A further object of the invention is to provide a method of preventing an inmate from committing suicide which will also indicate and sound an alarm should the inmate attempt to remove the bracelet from his/her wrist or ankle.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic drawing illustrating an inmate having the oximeter attached to his wrist;

FIG. 2 is a view similar to FIG. 1 except that the oximeter is attached to the inmate's ankle; and

FIG. 3 is a schematic drawing illustrating the bracelet which is attached to the inmate's wrist or ankle and which contains an oximeter and RF transmitter thereon.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

As stated above, if a person attempts suicide by hanging, the oxygen saturation of the person's blood will drop dramatically. The same is also true with the person's pulse rate should the person attempt suicide.

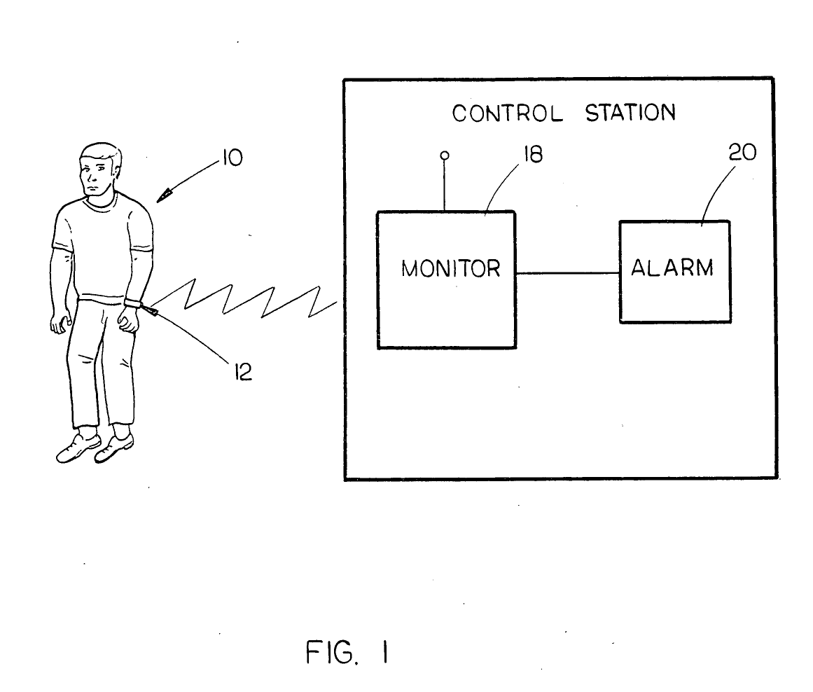

In FIG. 1, the numeral 10 refers to a person who may be (1) an inmate or patient in a psychiatric ward or hospital; or (2) an inmate or prisoner in a prison or jail cell. As used herein, “inmate” will refer to any person in a confined area who is suspected of having suicidal tendencies. To avoid having the inmate placed on continuous or periodic observations so that the inmate will not be able to commit suicide by hanging or slashed wrist or the like, the method of this invention is provided.

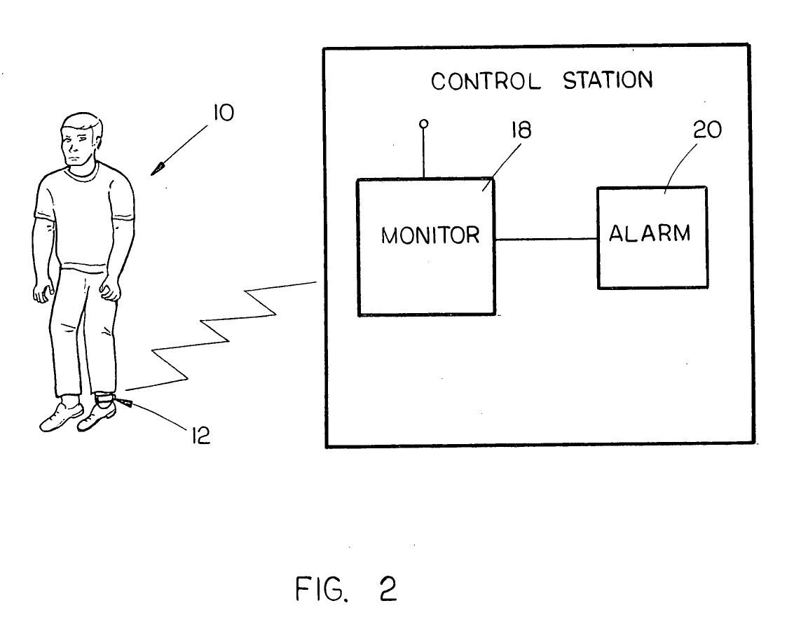

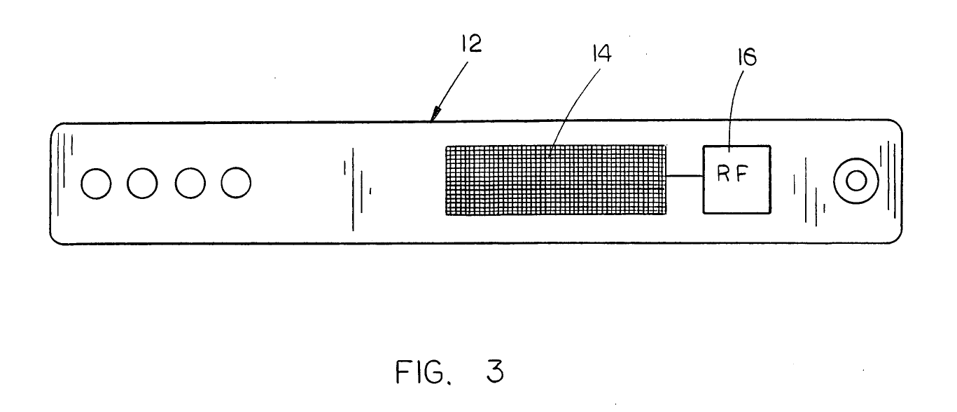

In FIG. 3, the numeral 12 refers to a bracelet of conventional design which is normally used on the wrist or ankle of the person confined to “house” arrest. The bracelet 12 should be difficult to remove and should be able to be locked onto the person's wrist or ankle. Bracelet 12 has a conventional oximeter 14 mounted on the inside surface thereof. Preferably, the oximeter 14 is a pulse oximeter. Oximeter 14 indirectly measures the oxygen saturation of the inmate's blood. Oximeter 14 is battery operated and supplies the inmate's oxygen saturation data to a radio frequency (RF) transmitter 16. If the oximeter 14 is a pulse oximeter, data relating to the pulse rate of the inmate will also be supplied to the transmitter 16. Radio transmitter 16 transmits the data to a remote medical monitor 18 at a central control station which is operatively connected to a visual and/or audio alarm. FIG. 1 illustrates the bracelet 12 being attached to the inmate's wrist while FIG. 2 illustrates the bracelet 12 being attached to the inmate's ankle.

Should the inmate attempt suicide by hanging or by slashing his/her wrists or the like, the inmate's blood oxygen saturation will dramatically drop with the transmitter 16 transmitting the data to the monitor 18 which includes an RF receiver. When the inmate's blood oxygen saturation level drops to a predetermined level, which will indicate that the inmate is hanging himself/herself or that the inmate has slashed his/her wrists or the like, the audio and/or visual alarm 20 will be activated so that personnel may quickly rush to the inmate's cell or room to stop the suicide in progress. The alarm 20 will also be activated should the inmate's pulse rate drop to a predetermined level if the oximeter is a pulse oximeter.

If the inmate is able to remove the bracelet 12 prior to attempting suicide, the oximeter 14 will detect a drop in the oxygen saturation level or a drop in the pulse rate which will also activate the alarm 20 so that personnel may quickly rush to the inmate's cell or room and replace the bracelet 12.

Thus it can be seen that a unique method has been provided for preventing an inmate from committing suicide. It can therefore be seen that the method of this invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. The method of preventing an inmate from committing suicide, comprising the steps of:
providing a battery operated oximeter having an RF transmitter associated therewith that will transmit a radio signal that contains data related to the calculated oxygen saturation level of the blood being sensed;
locking the oximeter on the ankle or wrist of the inmate so that the oximeter will gather data regarding the oxygen saturation level of the inmate's blood;
providing a monitor including an RF receiver in a location remote from the inmate;
transmitting an RF signal containing the data regarding the oxygen saturation level of the inmate to the monitor so that the monitor will indicate that the inmate is attempting suicide should the oxygen saturation level of the inmate's blood drop to a certain level; and
activating an alarm indicating that the inmate is possibly attempting to commit suicide.

2. The method of claim 1 wherein the oxygen saturation level of the inmate's blood is continuously monitored.

3. The method of claim 1 wherein the oximeter is a pulse oximeter and wherein the RF signal being transmitted to the monitor also includes pulse rate data.

4. The method of claim 1 wherein the inmate is housed in a jail cell.

5. The method of claim 1 wherein the inmate is housed in a prison cell.

6. The method of claim 1 wherein the patient is confined to a psychiatric ward.

7. The method of claim 1 wherein the oximeter and RF transmitter are locked onto the inmate's wrist or ankle by way of a bracelet.

8. The method of claim 6 wherein the alarm is activated if the inmate removes the bracelet from his/her wrist or ankle.

9. The method of claim 1 wherein the alarm comprises an audio alarm.

10. The method of claim 1 wherein the alarm comprises a visual alarm.

11. The method of claim 1wherein the alarm comprises an audio/visual alarm.
